(19) United States
(12) Patent Application Publication
(10) Pub. No.: US 2007/0277412 A1
(43) Pub. Date: Dec. 6, 2007

(54) Vehicular display support device

(76) Inventor: Michael V. Haubert, Mount Holly, NC (US)

Correspondence Address: Michael V Haubert, 133 Lighthouse Road, Mount Holly, NC, 28120, US

(21) Appl. No.: 11/801,164

(22) Filed: May 9, 2007

Related U.S. Application Data
(60) Provisional application No. 60/811,270, filed on Jun. 6, 2006.

(51) Int. Cl. G09F 21/04

(52) U.S. Cl. 40/593; 40/591

(57) ABSTRACT

A structural device to which is fastened planar displays or frames to support planer displays and the structural device attaches to a vehicle so as to support planar displays or frames to support a planer displays in the plane parallel to or near parallel to the rear or front surfaces of the vehicle. The structural device is comprised of a singular structural member or a plurality of concatenated structural members that are static, exhibit rotational or linear articulation, or exhibit rotational and linear articulation. The structural device attaches to the vehicle by means its structural members and its securing devices. The structural device is placed on the vehicle or parts attached to the vehicle. The securing devices attach to the vehicle and are manipulated to provide forces which in conjunction with the structural members fasten the invention to the vehicle or parts attached to the vehicle.

### CROSS-REFERENCES TO RELATED APPLICATIONS

This application claims the benefit of Provisional Application: U.S. Application No. 60/811,270 filed Jun. 6, 2006.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

1. Field of Invention

This invention is a vehicular display support device configured to act as a structure to which planer displays or frames that support planer displays are attached. The device attaches to a vehicle or attaches to parts attached to a vehicle. The device supports planer displays or frames that support a planer displays for presentation to vehicular occupants and pedestrians to the rear of or to the front of the vehicle equipped with this device.

2. Discussion of Relevant Art

Long before the introduction of motorized vehicles people recognized the opportunity vehicles presented in the promotion of information. Notable examples are circus wagons and political campaign wagons. It was only natural these methods of communication would be applied to motorized vehicles upon their introduction. To date most of the promotion is accomplished by applying a planer display, on which the message was applied, to the broad surfaces present on vehicles or is directly applied to the vehicle surfaces. While effective these devices are limited in their ability to rapidly remove the message from the vehicle. This inability to rapidly remove the message from the vehicle limits the utilization of the vehicle, particularly if the message is commercial in nature. Many public places, like National Parks, prohibit commercial vehicles within their boundaries.

Recently three devices have been developed that differ from the traditional method described above. There is disclosed in U.S. Pat. No. 6,918,200 a device entitled: BILLBOARD MANUFACTURE AND SUPPORT DEVICE. The patent shows device that supports a display leaf between two panels. The panels are suspended from the roof rack of the supporting vehicle in a vertical plane substantially parallel to the direction of vehicular motion. The panels are fastened to and positioned on the vehicle by means of mounting arms. The invention being applied for in this application is not reliant on a roof rack for support, conforms to the surface contours of the supporting vehicle, and displays in a vertical plane substantially perpendicular to the direction of vehicular motion.

There is disclosed in U.S. Pat. 6,789,833 a device entitled: TAILGATE ADVERTISING APPARATUS AND METHODS. The patent shows device that supports a billboard in a vertical plane substantially perpendicular to the direction of vehicular motion. The billboard is suspended from the tailgate of the supporting vehicle. The billboard is fastened to and positioned on the tailgate by means of a clamping bracket. The invention being applied for in this application mounts to the surface of the supporting vehicle, conforms to the surface contours of the supporting vehicle, and is not reliant on a tailgate for support.

There is disclosed in U.S. Pat. No. 6,892,486 a device entitled: BANNER DISPLAY SYSTEM. The patent shows device that supports a banner in a vertical plane. The banner is supported by a frame. The frame fastens to the roof of the supporting vehicle by suction cups. The invention being applied for in this application mounts to any surface of the supporting vehicle, conforms to the surface contours of the supporting vehicle, and is intended for use with the supporting vehicle moving or not moving.

### BRIEF SUMMARY OF THE INVENTION

This invention attaches to a vehicle by resting on the vehicles surface or surfaces or attaches to parts that are attached to the vehicle and is secured to the surface, surfaces, or parts by means of rigid or flexible or rigid and flexible securing devices made from natural or man-made or natural and man-made materials. Attached to the portion of the invention resting on the vehicles surface or surfaces or attached to parts that are attached to the vehicle is mounted a planer display or a frame that supports a planer display. The vehicular display support device presents the planer display or the frame that supports a planer display in a plane parallel or near parallel to the rear or front surfaces of the bearing vehicle at an elevation above the road surface so as to be readily viewable to vehicular occupants and pedestrians to the rear of or to the front of the vehicle equipped with this device. The invention is either fixed in construction allowing no articulation once attached to the bearing vehicle or is constructed with mechanical members that permit rotational and linear articulation or rotational or linear articulation. The articulating feature of the invention allows the device to move so as to not present itself as an obstacle to the operation of the vehicles doors, hatches, gates, or lids. A spoiler can be attached to the invention so as to offset pressure differentials that may occur as the planer display with the bearing vehicle moves through the air. The invention is equipped with a means of transferring electrical power to devices such as wiper mechanisms, marquee lighting, neon lighting, motors and other types of electrical and electromechanical apparatuses. The invention is equipped with a means of transferring electronic information to devices such as cathode ray tube displays, flat screen displays and other types of electronic appliances. The invention is equipped with a means of transferring electrical signals to electrical and electronic appliances.

### BRIEF DESCRIPTION OF THE SEVERAL VIEWS OF THE DRAWINGS

FIG. 1 shows a linearly articulating variation of the invention as it would appear to an outside observer if it were not attached to a vehicle.

FIG. 2 shows a linearly and rotationally articulating variation of the invention as it would appear to an outside observer if it were not attached to a vehicle.

FIG. 3 shows a rotationally articulating variation of the invention as it would appear to an outside observer if it were not attached to a vehicle.

FIG. 4 shows a non-articulating variation of the invention as it would appear to an outside observer if it were not attached to a vehicle.

FIG. 5 shows a rotationally articulating variation of the invention as it would appear to an outside observer if it were not attached to a vehicle.

FIG. 6 shows a linearly articulating variation of the invention as it would appear to an outside observer if it were not attached to a vehicle.

FIG. 7 shows a linearly and rotationally articulating variation of the invention as it would appear to an outside observer if it were not attached to a vehicle.

FIG. 8 shows a linearly articulating variation of the invention as it would appear to an outside observer if it were not attached to a vehicle.

FIG. 9 shows a linearly and rotationally articulating variation of the invention as it would appear to an outside observer if it were not attached to a vehicle.

### DETAILED DESCRIPTION OF THE INVENTION

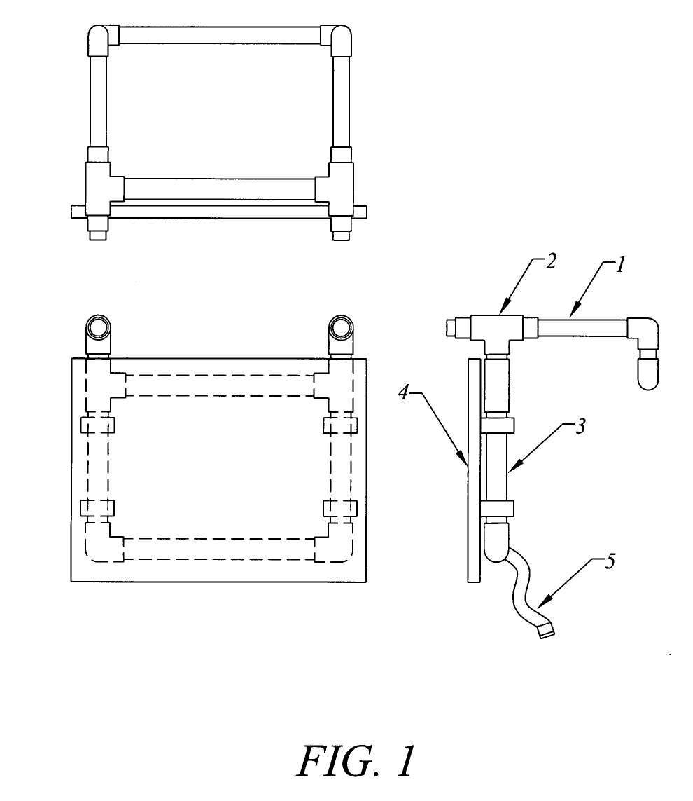

Refer to FIG. 1. This invention attaches to the vehicle or parts attached to a vehicle by means of members (1) and (3) and securing device (5). The invention is placed on the vehicle or the part attached to the vehicle. Member (1) moves lineally through member (2) and contacts the vehicle or part attached to the vehicle to create and apply a compressive interface between members (1) and (3). Member (1) is prevented from moving relative to member (2) by means of a movement restriction device associated with member (2). Securing device (5) attaches to the vehicle and is manipulated to provide a tensile or compressive force which in conjunction with members (1) and (3) fastens the invention to the vehicle or the part attached to the vehicle. Attached to member (3) is a planar display or a frame that supports a planer display (4).

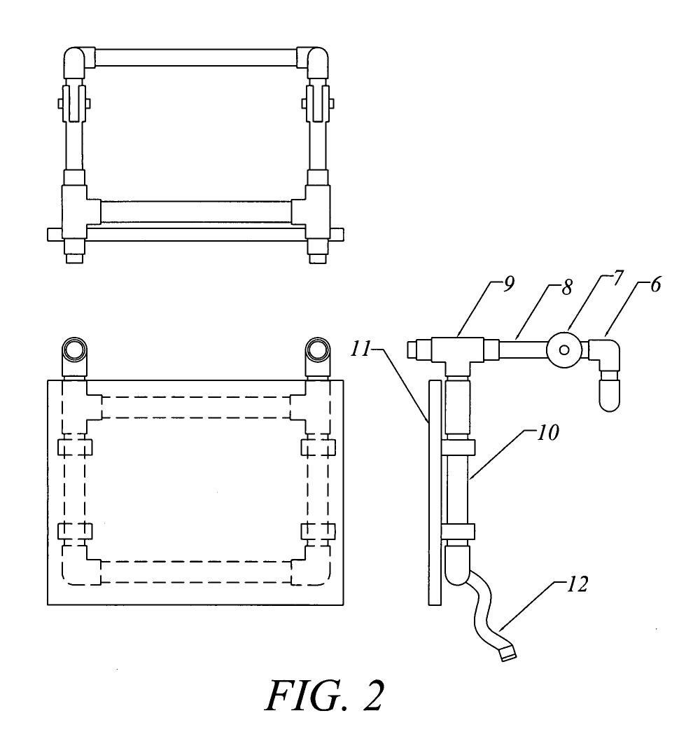

Refer to FIG. 2. This invention attaches to the vehicle or parts attached to a vehicle by means of members (6), (7), (8), (9) and (10) and securing device (12). The invention is placed on the vehicle or the part attached to the vehicle. Member (6) moves rotationally by means of rotational device (7). Member (8) moves lineally through member (9). Member (6) contacts the vehicle or part attached to the vehicle to create and apply a compressive interface between members (6) and (10). Member (6) is prevented from moving relative to member (8) by means of a movement restriction device associated with member (7). Member (8) is prevented from moving relative to member (9) by means of a movement restriction device associated with member (9). Securing device (12) attaches to the vehicle and is manipulated to provide a tensile or compressive force which in conjunction with members (6), (7), (8), (9) and (10) fastens the invention to the vehicle or the part attached to the vehicle. Attached to member (10) is a planar display or a frame that supports a planer display (11).

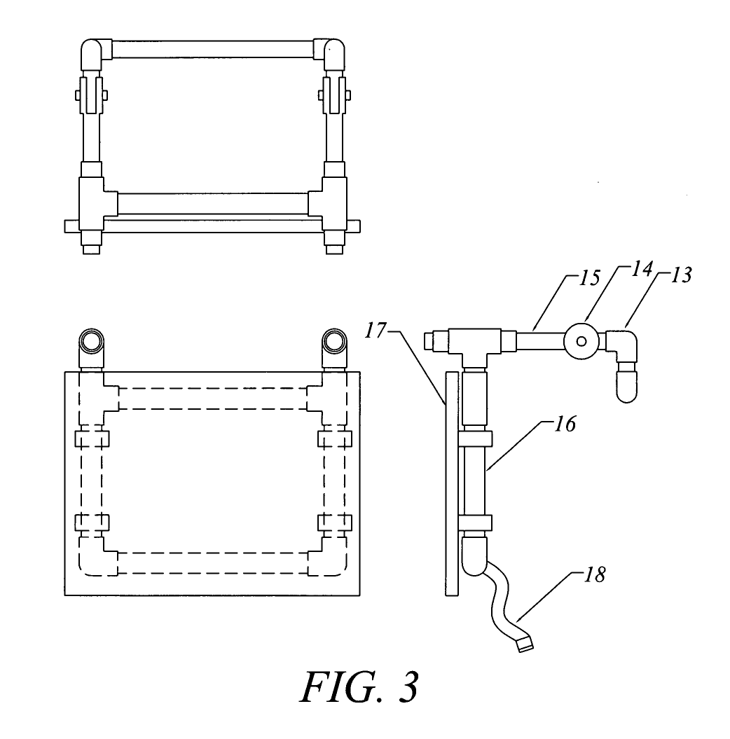

Refer to FIG. 3. This invention attaches to the vehicle or parts attached to a vehicle by means of members (13), (14), (15) and (16) and securing device (18). The invention is placed on the vehicle or the part attached to the vehicle. Member (13) moves rotationally by means of rotational device (14). Member (13) contacts the vehicle or part attached to the vehicle to create and apply a compressive interface between members (13) and (16). Member (13) is prevented from moving relative to member (15) by means of a movement restriction device associated with member (14). Securing device (18) attaches to the vehicle and is manipulated to provide a tensile or compressive force which in conjunction with members (13), (14), (15) and (16) fastens the invention to the vehicle or the part attached to the vehicle. Attached to member (16) is a planar display or a frame that supports a planer display (17).

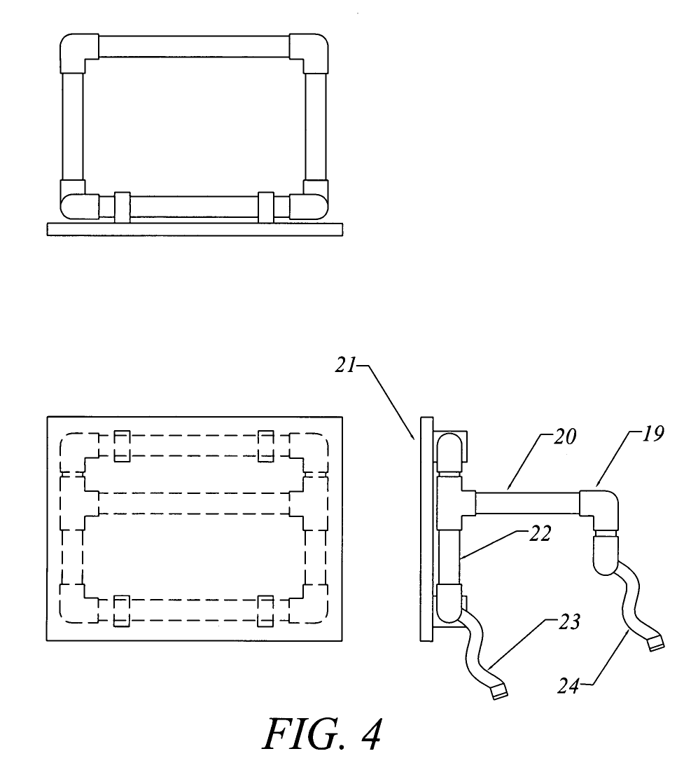

Refer to FIG. 4. This invention attaches to the vehicle or parts attached to a vehicle by means of members (19), (20), and (22) and securing devices (23) and (24). The invention is placed on the vehicle or the part attached to the vehicle. Members (19) and (22) contact the vehicle or part attached to the vehicle. Securing devices (23) and (24) attach to the vehicle and are manipulated to provide a tensile or compressive force which in conjunction with members (19) and (22) fastens the invention to the vehicle or the part attached to the vehicle. Attached to member (22) is a planar display or a frame that supports a planer display (21).

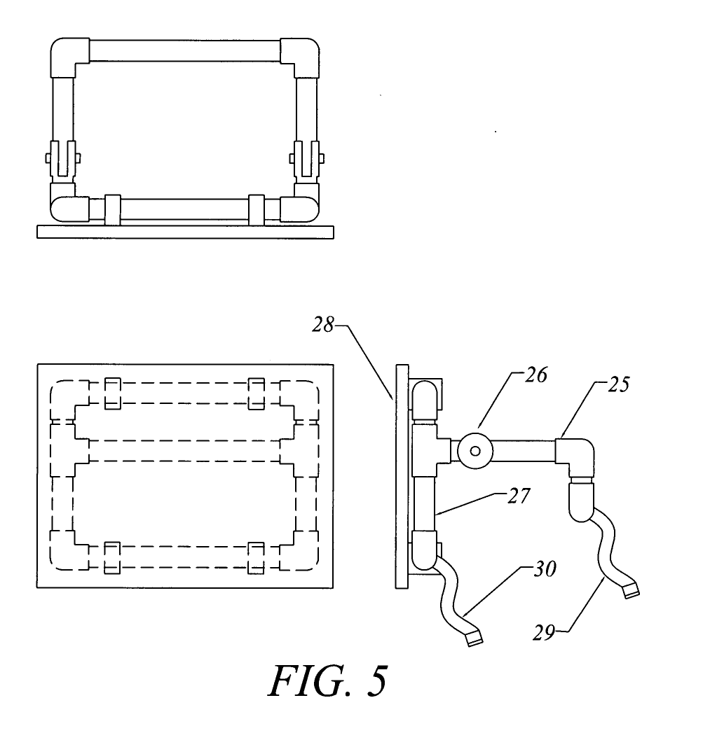

Refer to FIG. 5. This invention attaches to the vehicle or parts attached to a vehicle by means of members (25) and (27) and securing devices (29) and (30). The invention is placed on the vehicle or the part attached to the vehicle. Member (25) moves rotationally by means of rotational device (26). Member (25) is prevented from moving relative to member (27) by means of a movement restriction device associated with member (26). Members (25) and (27) contact the vehicle or part attached to the vehicle. Securing devices (29) and (30) attach to the vehicle and are manipulated to provide a tensile or compressive force which in conjunction with members (25) and (27) fastens the invention to the vehicle or the part attached to the vehicle. Attached to member (27) is a planar display or a frame that supports a planer display (28).

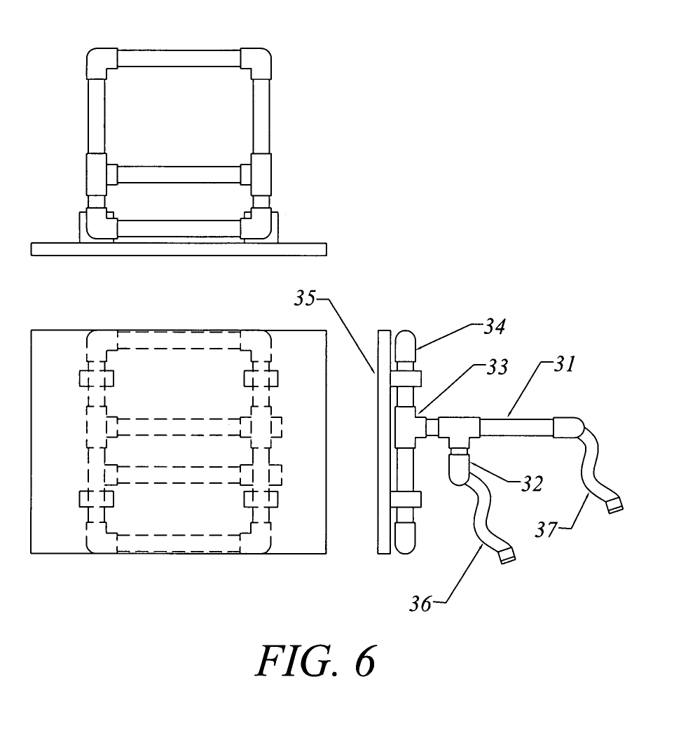

Refer to FIG. 6. This invention attaches to the vehicle or parts attached to a vehicle by means of members (31) and (32) and securing devices (36) and (37). The invention is placed on the vehicle or the part attached to the vehicle. Securing devices (36) and (37) attach to the vehicle and are manipulated to provide a tensile or compressive force which in conjunction with members (31) and (32) fastens the invention to the vehicle or the part attached to the vehicle. Member (34) moves lineally through member (33) to position member (34) relative to member (33). Member (34) is prevented from moving relative to member (33) by means of a movement restriction device associated with member (33). Attached to member (34) is a planar display or a frame that supports a planer display (35).

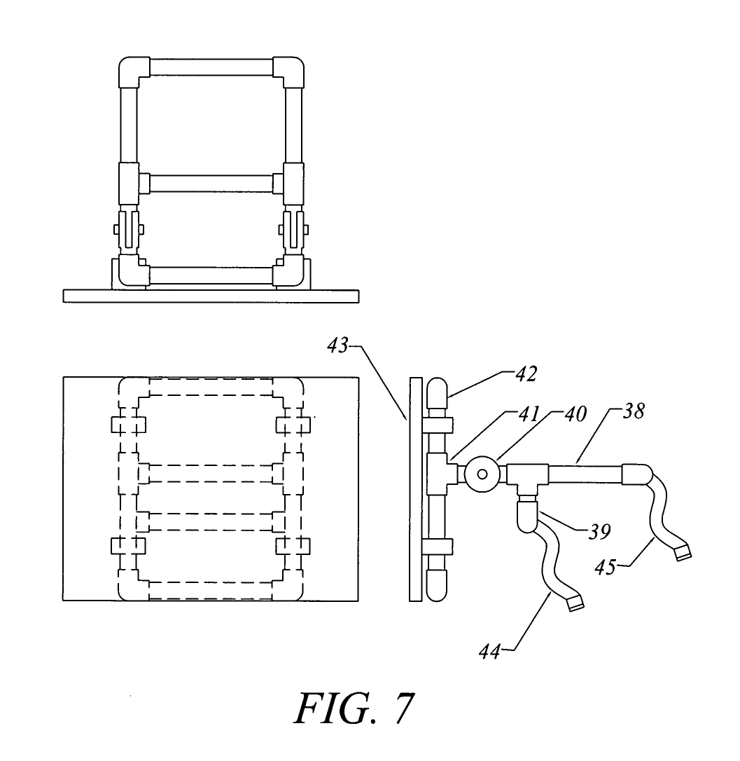

Refer to FIG. 7. This invention attaches to the vehicle or parts attached to a vehicle by means of members (38) and (39) and securing devices (44) and (45). The invention is placed on the vehicle or the part attached to the vehicle. Securing devices (44) and (45) attach to the vehicle and are manipulated to provide a tensile or compressive force which in conjunction with members (38) and (39) fastens the invention to the vehicle or the part attached to the vehicle. Member (41) moves rotationally relative to members (38) and (39) by means of rotational device (40). Member (41) is prevented from moving relative to members (38) and (39) by means of a movement restriction device associated with member (40). Member (42) moves lineally through member (41) to position member (42) relative to member (41). Member (42) is prevented from moving relative to member (41) by means of a movement restriction device associated with member (41). Attached to member (42) is a planar display or a frame that supports a planer display (43).

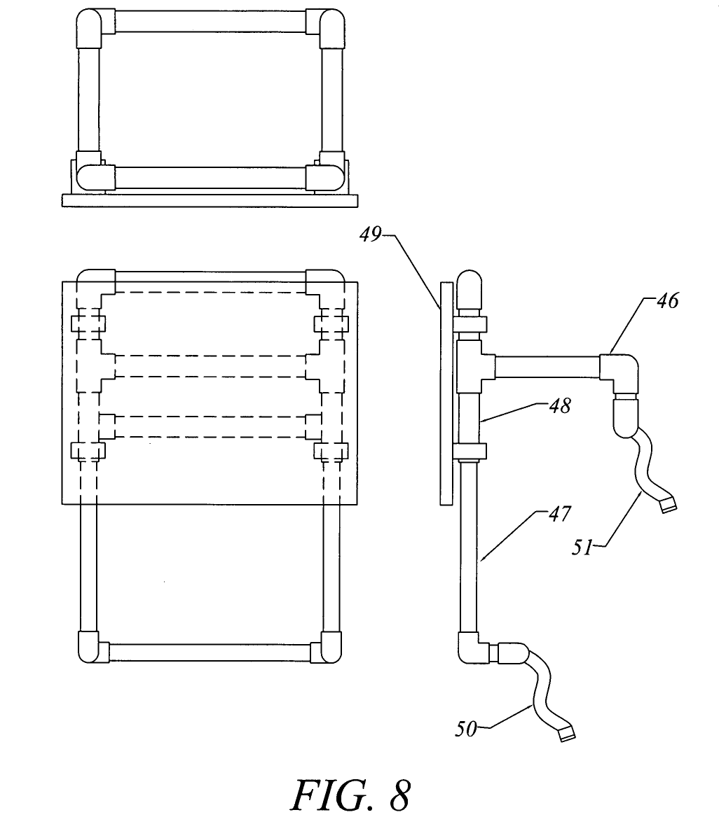

Refer to FIG. 8. This invention attaches to the vehicle or parts attached to a vehicle by means of members (46) and (47) and securing devices (50) and (51). The invention is placed on the vehicle or the part attached to the vehicle. Securing devices (50) and (51) attach to the vehicle and are manipulated to provide a tensile or compressive force which in conjunction with members (46) and (47) fastens the invention to the vehicle or the part attached to the vehicle. Member (47) moves lineally through member (48) to position member (47) relative to member (48). Member (47) is prevented from moving relative to member (48) by means of a movement restriction device associated with member (48). Attached to members (47) and (48) is a planar display or a frame that supports a planer display (49).

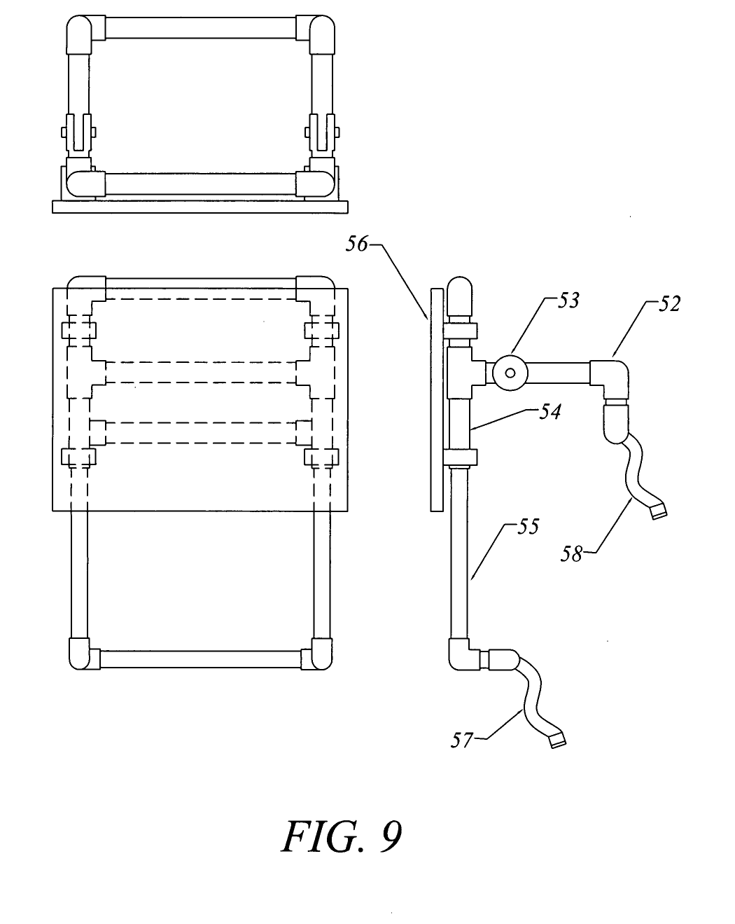

Refer to FIG. 9. This invention attaches to the vehicle or parts attached to a vehicle by means of members (52) and (55) and securing devices (57) and (58). The invention is placed on the vehicle or the part attached to the vehicle. Securing devices (57) and (58) attach to the vehicle and are manipulated to provide a tensile or compressive force which in conjunction with members (52) and (55) fastens the invention to the vehicle or the part attached to the vehicle. Member (52) moves rotationally relative to members (54) and (55) by means of rotational device (53). Member (52) is prevented from moving relative to members (54) and (55) by means of a movement restriction device associated with member (53). Member (55) moves lineally through member (54) to position member (55) relative to member (54). Member (55) is prevented from moving relative to member (54) by means of a movement restriction device associated with member (54). Attached to members (54) and (55) is a planar display or a frame that supports a planer display (56).

I claim:

1. A vehicular display support device configured to act as a planer display or planer displays, support a planer display or planer displays, or support a frame or frames supporting a planer display or planer displays in order to present a planer display or planer displays in a plane parallel to the front and rear surfaces of a vehicle or in a plane parallel to the front or rear surfaces of a vehicle, comprising:
an articulating or a non-articulating structural device that rests on, mounts to, or attaches to the surface of a vehicle supporting a singular support member supporting a planer display or planer displays or a frame or frames supporting a planer display or planer displays or a plurality of support members supporting a planer display or planer displays or a frame or frames supporting a planer display or planer displays;
a planer display or planer displays or a frame or frames supporting a planer display or planer displays;
a flexible or a rigid securing device, flexible or rigid securing devices, a flexible and a rigid securing device, or flexible and rigid securing devices for fastening or securing the structural device to the surface of the vehicle;
a nonabrasive protective materials and devices or a nonabrasive protective materials or devices attached to or associated with the vehicular display support device to prevent damage to the surface of the vehicle and to prevent damage to the surface finish of the vehicle;
a spoiler, an air foil, or a spoiler and an air foil;
an apparatus for transferring electrical power from an electrical power source to a planer display or a frame supporting a planer display;
an apparatus for transferring electronic information from an electronic information source to a planer display or a frame supporting a planer display;
an apparatus for transferring an electrical signal from an electrical signal source to a planer display or a frame supporting a planer display.

2. The device of claim 1 wherein said vehicular display support device comprises of at least one structural member.

3. The device of claim 1 wherein said vehicular display support device comprises of at least two concatenated structural members.

4. The device of claim 1 wherein said vehicular display support device comprises of at least one planer display or frame to support a planer display with said planer display or said frame fastened to or attached to said structural member.

5. The device of claim 4 wherein said planer display or said frame or said planer displays or said frames fastens to or attaches to said structural member at multiple positions on said structural member.

6. The device of claim 4 wherein said frame comprises of at least one member.

7. The device of claim 4 wherein said frame comprises of at least two concatenated members.

8. The device of claim 1 wherein said articulating structural device articulates in a rotational manner, articulates in a linear manner, or articulates in a rotational and a linear manner.

9. The device of claim 8 wherein the articulation in a rotational manner is achieved with the use of a singular rotational apparatus or plurality of rotational apparatuses or a singular ball and socket apparatus or plurality of ball and socket apparatuses.

10. The device of claim 8 wherein the articulation in a linear manner is achieved with the use of a singular linear motion apparatus or plurality of linear motion apparatuses.

11. The device of claim 1 wherein said flexible or rigid securing device or devices fastens to or attaches to the structural device by means of flexible or rigid loops, mechanical fasteners, adhesives, hooks, clips, buckles, magnets, suction cups, or knots.

12. The device of claim 1 wherein said flexible or rigid securing device or devices fastens to or attaches to the vehicle by means of flexible or rigid loops, mechanical fasteners, adhesives, hooks, clips, buckles, magnets, suction cups, or knots.

13. The device of claim 12 wherein said a flexible or a rigid securing device or devices, said flexible or rigid loops, said mechanical fasteners, said adhesives, said hooks, said clips, said buckles, said magnets, said suction cups, and said knots are coated with nonabrasive protective materials to prevent damage to the surface of the vehicle and to prevent damage to the surface finish of the vehicle.

14. The device of claim 1 wherein said structural device is comprised of man made materials, natural materials, or man made and natural materials.

15. The device of claim 1 wherein the surfaces of said vehicular display support device are coated to prevent and inhibit degradation.

16. The device of claim 1 wherein said spoiler attaches to said structural member or to said planer display or to said frame to disrupt the air flows and air pressure differentials in the proximity of said planer display or said frame.

17. The device of claim 1 wherein said apparatus for transferring electrical power provides electrical power to electrical and electromechanical appliances, said electrical and electromechanical appliances being attached to or a member of said planer display or planer displays or said frame or said frames.

18. The device of claim 1 wherein said apparatus for transferring electronic information provides electronic information to electronic appliances, said electronic appliances being attached to or a member of said planer display or said planer displays or said frame or said frames.

19. The device of claim 1 wherein said apparatus for transferring an electrical signal provides an electrical signal to electrical and electronic appliances said electrical and electronic appliances being attached to or a member of said planer display or said planer displays or said frame or said frames.

20. The device of claim 1 wherein said structural support member is fashioned to accept a chain or similar device for the purpose of attachment to the bearing vehicle and serving as a safety device.
